(19) United States
(12) Patent Application Publication
(10) Pub. No.: US 2026/0237336 A1
(43) Pub. Date: Aug. 13, 2026

(54) ELECTRONIC LABEL DEVICE

(71) Applicants: Hyeonjoon RYU, Seoul (KR); Eunkoung YIM, Seoul (KR); Jiwoong RYU, Seoul (KR); Sia RYU, Seoul (KR)

(72) Inventors: Hyeonjoon RYU, Seoul (KR); Eunkoung YIM, Seoul (KR); Jiwoong RYU, Seoul (KR); Sia RYU, Seoul (KR)

(21) Appl. No.: 19/086,193

(22) Filed: Mar. 21, 2025

(30) Foreign Application Priority Data
Feb. 11, 2025 (KR) 10-2025-0017234

(51) Int. Cl. G09G 3/20

(52) U.S. Cl. CPC G09G 3/2003; G09G 2380/04

(57) ABSTRACT

According to one aspect of the proposed invention, a refreshing control operation of activating a display driving circuit according to a first event of a timer circuit which is generated according to a refreshing cycle and driving the display driving circuit such that a plurality of images are displayed on an electronic paper display in a sequence in which regions of the images are displayed in colors in sequence according to the refreshing cycle is performed to promote product sales and maximize advertising effects.

### CROSS-REFERENCE TO RELATED APPLICATION(S)

This application claims priority from Korean Patent Application No. 10-2025-0017234 filed on Feb. 11, 2025, in the Korean Intellectual Property Office, the disclosure of which is incorporated herein by reference in its entirety.

### BACKGROUND

### 1. Field

The following description relates to an electronic label device, and more specifically, to an electronic label device that electronically displays information on products displayed in a store and a display method thereof.

### 2. Description of Related Art

Electronic information labels (EILs) or electronic shelf labels (ESLs) are electronic devices that electronically display information on products instead of paper labels on a shelf for products in a store. Since the electronic label devices are installed in thousands in each store and operated by batteries, the cost and work of replacing the batteries are a huge burden. Accordingly, low-power design that allows electronic label devices to operate for a long period of time at low power is important.

To reduce power consumption of electronic label devices, which are generally powered by batteries thereof, the electronic label devices are kept in a sleep state except for a wakeup time period required for the information update. During the wakeup time period, an electronic label device listens to communication from a server, and when there is data to be received from the server, the electronic label device enters a data reception mode to receive the data, stores the data, and displays the data. In addition, for low-power operation, electronic paper displays (EPDs) that maintain an information display state even when power is not supplied thereto have been mainly adopted.

Korean Patent Laid-open Publication No. 10-2016-0078206, titled “Display management device and method for electronic label,” discloses a technology in which a refreshing cycle is linked with the update of product information and refreshing is performed when the product information is updated, to reduce power consumption. However, since confusing images are displayed during a refreshing period, customers in a store sometimes misunderstand that a failure has occurred. Therefore, a technology to avoid such mistakes and provide meaningful information to customers during the refreshing period that is meaningless to the customers is needed.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The following description relates to an electronic label device that prevents consumer misunderstanding of failure when refreshing is performed.

Furthermore, the following description relates to an electronic label device that achieves an effect of advertisement for promoting product sales through electronic labels.

Furthermore, the following description relates to a method of providing product advertisement without increasing power consumption in an electronic label device.

According to one aspect of the proposed invention, an electronic label device activates a display driving circuit according to a first event of a timer circuit which is generated according to a refreshing cycle and allows the plurality of images to be displayed on the electronic paper display in a sequence in which regions of the images are displayed in colors in sequence according to the refreshing cycle.

According to an additional aspect of the proposed invention, when updating a product information display, an electronic label device alternately displays a positive advertising image and a negative advertising image on an electronic paper display multiple times before displaying updated product information.

Other features and aspects will be apparent from the following detailed description, the drawings, and the claims.

### BRIEF DESCRIPTION OF THE DRAWINGS

FIG. 1 shows an electronic label system including an electronic label device according to one embodiment.

FIG. 2 is a block diagram showing a configuration of the electronic label device according to one embodiment.

FIG. 3 shows the electronic label device displaying a positive advertising image and a negative advertising image in two colors according to one embodiment.

FIG. 4 shows a sequence chart in which three advertising images having different colors are sequentially displayed on an electronic paper display (EPD) according to a refreshing sequence according to one embodiment.

FIG. 5 shows a sequence chart in which four advertising images having different colors are sequentially displayed on the EPD according to a refreshing sequence according to one embodiment.

FIG. 6 shows a sequence chart in which four advertising images having different colors are sequentially displayed on the EPD according to a refreshing sequence according to another embodiment.

FIG. 7 shows a sequence chart in which four advertising images having different colors are sequentially displayed on the EPD according to a refreshing sequence while the colors that are driven at a high voltage and the colors that are driven at a low voltage are distinguished from each other, according to further another embodiment.

FIG. 8 is a block diagram showing a configuration of an electronic label device with a direct memory access controller (DMAC) added to the block diagram of FIG. 2 according to one embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The above-described and additional aspects are implemented in embodiments described with reference to the attached drawings. It is seen that components of each embodiment can be combined in various ways within one embodiment or with components of another embodiment, as long as there is no other mention or contradiction between the components. Terms used in this specification and claims should be interpreted with meanings and concepts that conform to the content described or the technical idea proposed based on the principle that the inventor can appropriately define the concepts of the terms in order to describe his or her own invention in the best way.

In this specification, blocks expressed as “circuits” or “units” with reference to a block diagram may include hardware, such as a dedicated semiconductor, a gate array, and a field programmable gate array (FPGA), or some thereof. One or more blocks can be implemented in a single unit of hardware. As another example, these blocks may be implemented in software as an information processing unit in which a computing element executes program instructions stored in a memory element. A plurality of blocks can be implemented as some of a program(executable instruction) that is executed in the same computing element. As another example, these blocks can be implemented in a hybrid form in which some individual circuits are hardware and some are software. In addition, in the software implementation, the computing element can include a digital signal processor, computation-specific processors, an artificial intelligence processing engine, an artificial intelligence-specific processor, graphics processors, or a combination thereof within a possible range.

Hereinafter, exemplary embodiments of the present invention will be described in detail with reference to the accompanying drawings.

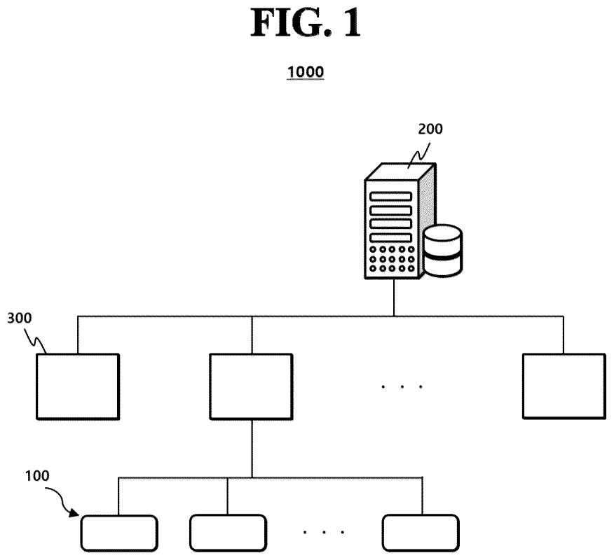

FIG. 1 shows an electronic label system including an electronic label device according to one embodiment. An electronic label system 1000 according to one embodiment may include an electronic label management server 200, a plurality of relays 300, and a plurality of electronic label devices 100. The electronic label management server 200 may transmit data to the plurality of electronic label devices 100 that are divided into a plurality of groups and managed by the relays 300. The electronic label management server 200 may be connected to the relay 300 via a wired connection such as Ethernet or via wireless Internet. The relay 300 and the electronic labels of the group belonging to the relay may communicate with each other according to short-range wireless communication, for example, a combination of a non-standard manner and all or some layers of a ZigBee protocol or a Bluetooth low energy (BLE) manner defined in a Bluetooth standard.

According to one aspect, a plurality of advertising images having color arrangements according to a refreshing sequence are prepared in a memory, the advertising images are alternately displayed at each refreshing cycle, and as a result, refreshing is performed.

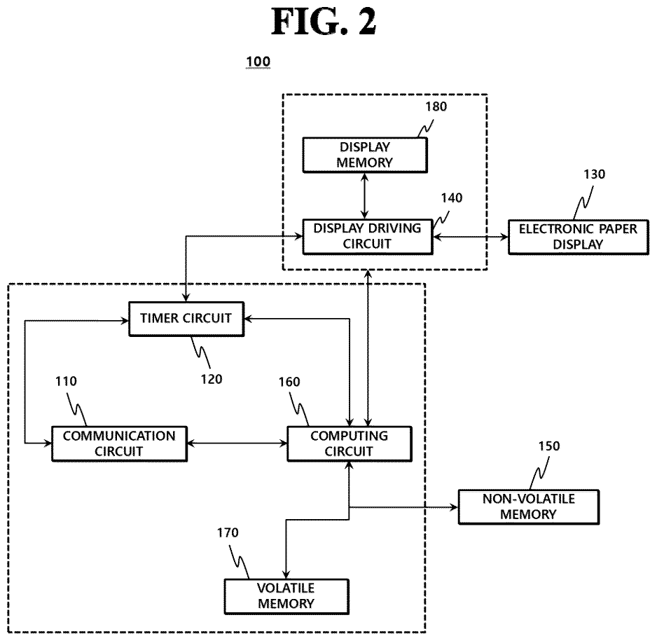

FIG. 2 is a block diagram showing a configuration of the electronic label device according to one embodiment applied to the aspect. As illustrated, the electronic label device 100 according to one embodiment includes a communication circuit (communication circuit) 110, a timer circuit 120, an electronic paper display (EPD) 130, a display driving circuit 140, a non-volatile memory 150, and a computing circuit 160. Additionally, the electronic label device 100 may further include a volatile memory 170 or a display memory 180 depending on a memory structure.

Additionally, according to one embodiment, the communication circuit 110, the timer circuit 120, the computing circuit 160, and the volatile memory 170 may be integrated as a single chip system such as a system on chip (SoC) (see a dotted line).

The communication circuit 110 may perform communication according to, for example, a combination of a non-standard manner and all or some layers of a ZigBee or Bluetooth low power communication circuit and software stacks thereof.

The timer circuit 120 may include a plurality of programmable timer circuit channels and may be implemented as a known circuit such as a counter and timer circuit circuit. The timer circuit 120 may be activated to operate even when the computing circuit 160 is in a sleep mode (a sleep state) and generate an interruption at a regular cycle set by the computing circuit 160 to wake up the computing circuit 160. The timer circuit 120 may generate a first event according to the refreshing cycle. The first event may be an event to perform refreshing, and the refreshing may be an operation to greatly shake micro color particles for resetting the micro color particles to solve a problem of the EPD not being able to display information with a clear contrast ratio and appearing like a residual image.

The EPD 130 may be, for example, an electrophoretic display having bistability in which microcapsules are encapsulated between a transparent electrode and a driving electrode, the microcapsules are specifically arranged in response to a voltage applied to the two electrodes to change a display state, and the display state is maintained even when the driving voltage is removed. For example, the EPD 130 may be a black and white display in which each pixel is switched between black and white. As another example, the EPD 130 may be a red and white display in which each pixel is switched between red and white. As another example, the EPD 130 may be a blue and white display in which each pixel is switched between blue and white. As another example, the EPD 130 may be a multi-color EPD capable of displaying primary colors and additional colors. As the multi-color EPD, color displays that display four colors (red, yellow, black, and white), three colors (red, white, and black), and seven colors are known.

Since the display of the EPD is not perfect, the color particles arranged according to the applied driving voltage are disrupted over time. In the case of the multi-color EPD, the display state is more easily disrupted, and thus a residual image is displayed. Accordingly, the EPD requires refreshing that is determined by a display manner thereof. Depending on a type of the electronic paper display, a refreshing method or a driving manner may vary. Typically, in refreshing a two-color EPD, a process in which a first color is displayed over the entire surface and then a second color is displayed over the entire surface is repeated several times to eliminate a residual image. In refreshing a multi-color EPD, a set color display sequence is repeated several times to eliminate a residual image.

The display driving circuit 140 drives the display of the EPD 130. The display driving circuit 140 may include a separate memory (e.g., RAM) therein.

The non-volatile memory 150 may store a plurality of images and programs(executable instructions), wherein the plurality of images have at least two regions arranged in identical patterns and layouts but distinguished by different colors, individual regions have different colors assigned between images, and when any one region is focused on among the plurality of images, colors of corresponding regions are assigned according to a refreshing sequence.

The computing circuit 160 may execute the program(executable instruction) to control the electronic label device 100. The computing circuit 160 may include, for example, an ARM CORE or a microprocessor, but the present invention is not limited thereto. The program includes software for operating the computing circuit 160.

According to an additional aspect of the proposed invention, in the electronic label device, the advertising images stored in the non-volatile memory may include a positive advertising image (#1 Image) formed of a first region A1 having a first color and a second region A2 having a second color, and a negative advertising image (#2 Image) formed of a first region A1 having a second color and a second region A2 having a first color.

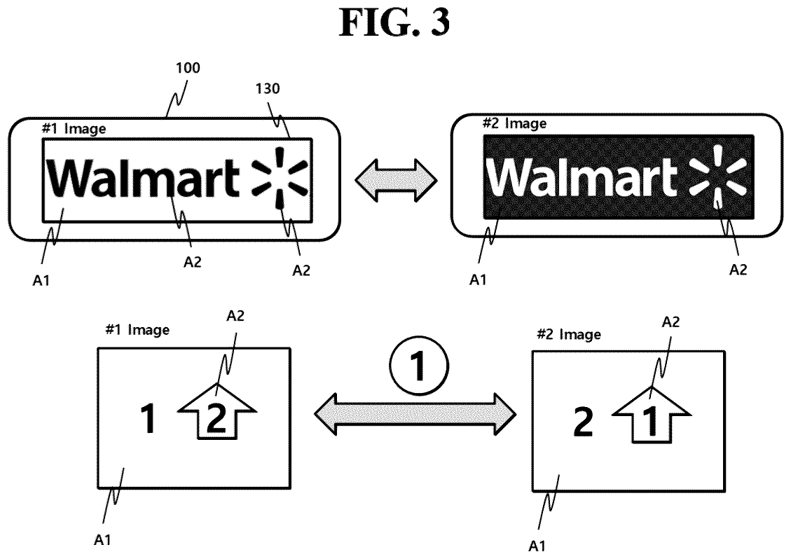

FIG. 3 shows the electronic label device displaying a positive advertising image and a negative advertising image in two colors according to one embodiment. The electronic label device 100 according to the illustrated embodiment may be a two-color EPD of black and white, blue and white, or red and white capable of expressing two colors for every pixel.

In the electronic label device of FIG. 3, when a first advertising image (#1 Image) is the positive advertising image, a second advertising image (#2 Image) is the negative advertising image. Also, the opposite may be possible. The advertising image may be a simple phrase or picture such as a company name, company logo image, Christmas message, year-end message, or new year message, but the present invention is not limited thereto. The positive advertising image and the negative advertising image are sequentially displayed on the EPD 130 of the electronic label device 100. In this way, two advertising images may be alternately displayed several times according to the refreshing sequence.

According to one embodiment, a refreshing control operation performed by the program may be an operation of driving the display driving circuit 140 such that the positive advertising image (#1 Image) and the negative advertising image (#2 Image) are alternately displayed on the EPD.

According to one aspect, when the EPD is a two-color display, the advertising image may include a positive advertising image formed of a first region having a first color and a second region having a second color, and a negative advertising image formed of colors reversed to those of the positive advertising image. FIG. 3 illustrates an example of two advertising images according to this aspect, that is, the positive advertising image and the negative advertising image.

In the illustrated embodiment, a plurality of images having at least two regions distinguished by different colors include a positive advertising image (#1 Image) formed of a first region having a first color and a second region having a second color, and a negative advertising image (#2 Image) formed of a first region having a second color and a second region having a first color. In this case, the refreshing control operation performed by the program may be an operation of driving the display driving circuit such that the positive advertising image and the negative advertising image are alternately displayed on the EPD.

For example, the plurality of images may include a positive advertising image (#1 Image) formed of a first region A1 having a first color (white) and a second region A2 having a second color (black), and a negative advertising image (#2 Image) formed of a first region A1 having the second color (black) and a second region A2 having the first color (white). Here, the first region of the positive advertising image and the first region of the negative advertising image are regions that have the same display shape and different colors. Similarly, the second region of the positive advertising image and the second region of the negative advertising image are regions that have the same display shape and different colors. The first region A1 may be a region in which a “background” is displayed, and the second region A2 may be a region in which “text or a picture” is displayed. The refreshing control operation performed by the program may be an operation of driving the display driving circuit 140 such that the positive advertising image and the negative advertising image are alternately displayed on the EPD. As the first color and the second color, various colors may be used.

The positive advertising image (the first advertising image, #1 Image) and the negative advertising image (the second advertising image, #2 Image) may be stored in the non-volatile memory 150. The non-volatile memory 150 may be formed as a flash memory having non-volatile characteristics, and the present invention is not limited thereto.

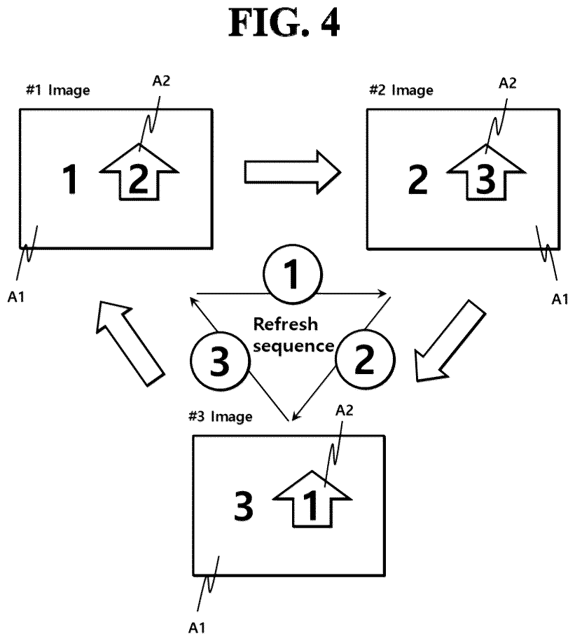

According to an additional aspect of the proposed invention, the present invention may be applied to an EPD displaying three colors. FIG. 4 illustrates an example of a display sequence applied in the EPD to which this aspect is applied. FIG. 4 shows a sequence chart in which three advertising images having different colors are sequentially displayed on the EPD according to the refreshing sequence according to one embodiment.

In the illustrated embodiment, a plurality of images having at least two regions distinguished by different colors include a first advertising image (#1 Image) formed of a first region A1 having a first color and a second region A2 having a second color, a second advertising image (#2 Image) formed of a first region A1 having the second color and a second region A2 having a third color, and a third advertising image (#3 Image) formed of a first region A1 having the third color and a second region A2 having the first color. In this case, the refreshing control operation performed by the program may be an operation of driving the display driving circuit such that a process in which the first advertising image (#1 Image), the second advertising image (#2 Image), and the third advertising image (#3 Image) are sequentially displayed on the EPD is repeated multiple times.

According to one embodiment, the images stored in the non-volatile memory include a first advertising image (#1 Image) formed of a first region A1 having a first color and a second region A2 having a second color, a second advertising image (#2 Image) formed of a first region A1 having the second color and a second region A2 having a third color, and a third advertising image (#3 Image) formed of a first region A1 having the third color and a second region A2 having the first color. The refreshing control operation performed by the program may be an operation of driving the display driving circuit such that a process in which the first advertising image, the second advertising image, and the third advertising image are sequentially displayed (\textcircled{1}\textcircled{2}\textcircled{3}) on the EPD is repeated multiple times.

According to an additional aspect of the proposed invention, the advertising images may include four or more images, and the advertising images may be sequentially displayed on the EPD.

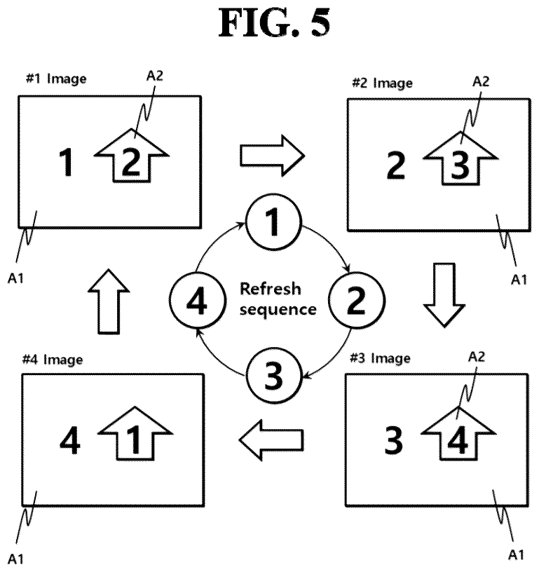

FIG. 5 shows a sequence chart in which four advertising images having different colors are sequentially displayed on the EPD according to a refreshing sequence according to one embodiment. As illustrated, the images stored in the non-volatile memory may be a first advertising image (#1 Image), a second advertising image (#2 Image), a third advertising image (#3 Image), and a fourth advertising image (#4 Image), and each image may be formed of different colors.

According to one embodiment, the images stored in the non-volatile memory 150 may include a first advertising image (#1 Image) formed of a first region A1 having a first color and a second region A2 having a second color, a second advertising image (#2 Image) formed of a first region A1 having the second color and a second region A2 having a third color, a third advertising image (#3 Image) formed of a first region A1 having the third color and a second region A2 having a fourth color, and a fourth advertising image (#4 Image) formed of a first region A1 having the fourth color and a second region A2 having the first color.

The refreshing control operation performed by the program may be an operation of driving the display driving circuit such that a process in which the first advertising image, the second advertising image, the third advertising image, and the fourth advertising image are sequentially displayed (\textcircled{1}\textcircled{2}\textcircled{3}\textcircled{4}) on the EPD is repeated multiple times.

According to one embodiment, the images stored in the non-volatile memory may be a first advertising image (#1 Image), a second advertising image (#2 Image), a third advertising image (#3 Image), and a fourth advertising image (#4 Image).

The first advertising image (#1 Image) may be formed of a first region having a first color and a second region having a second color, the second advertising image (#2 Image) may be formed of a first region having the second color and a second region having a third color, the third advertising image (#3 Image) may be formed of a first region having the third color and a second region having a fourth color, and the fourth advertising image (#4 Image) may be formed of a first region having the fourth color and a second region having the first color. The first region may be a region in which a “background” is displayed, and the second region may be a region in which “text or a picture” is displayed.

According to one embodiment, the refreshing control operation performed by the program may be an operation of driving the display driving circuit such that a process in which the first advertising image (#1 Image), the second advertising image (#2 Image), the third advertising image (#3 Image), and the fourth advertising image (#4 Image) are sequentially displayed on the EPD is repeated multiple times.

For example, the first advertising image (#1 Image) may be formed of a first region having a first color (white) and a second region having a second color (black), the second advertising image (#2 Image) may be formed of a first region having the second color (black) and a second region having a third color (red), the third advertising image (#3 Image) may be formed of a first region having the third color (red) and a second region having a fourth color (blue), and the fourth advertising image (#4 Image) may be formed of a first region having the fourth color (blue) and a second region having the first color (white), and the advertising images may be sequentially displayed on the EPD.

When the electronic label device is designed in this way, advertising images which are displayed in more than four colors may be displayed sequentially on the EPD.

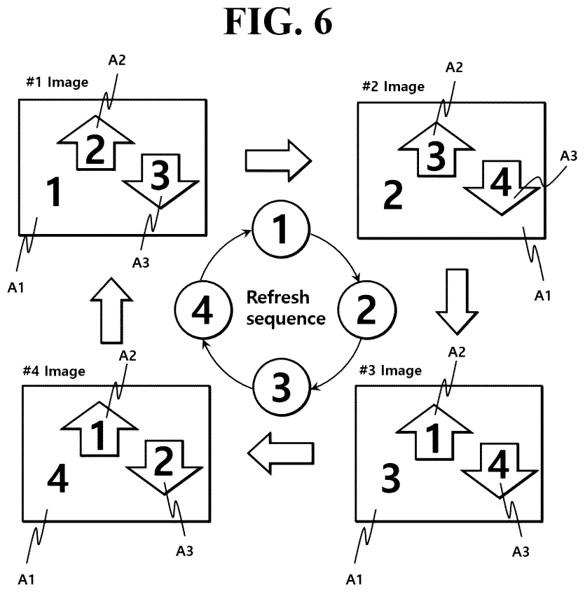

FIG. 6 shows a sequence chart in which four advertising images having different colors are sequentially displayed on the EPD according to a refreshing sequence according to another embodiment. As illustrated, four advertising images having different colors may be displayed sequentially on the EPD according to a refreshing sequence, with three colors being “simultaneously” displayed on the EPD in one image.

For example, the first advertising image (#1 Image) may be formed of a first region A1 having a first color (white), a second region A2 having a second color (black), and a third region A3 having a third color (red), the second advertising image (#2 Image) may be formed of a first region A1 having the second color (black), a second region A2 having the third color (red), and a third region A3 having a fourth color (yellow), the third advertising image (#3 Image) may be formed of a first region A1 having the third color (red), a second region A2 having the first color (white), and a third region A3 having a fourth color (blue), and the fourth advertising image (#4 Image) may be formed of a first region A1 having the fourth color (blue), a second region A2 having the first color (white), and a third region A3 having the second color (black), and the advertising images may be sequentially displayed (\textcircled{1}\textcircled{2}\textcircled{3}\textcircled{4}) on the EPD. In this way, four advertising images in which three colors are displayed and which have different colors may be repeatedly displayed several times according to the refreshing sequence. The first region A1 may be a region in which a background is displayed, and the second region A2 and the third region A3 may be regions in which text or a picture is displayed and which are displayed in different colors.

According to an additional aspect of the proposed invention, in the electronic label device, for the colors that are driven at a high voltage, a positive advertising image and a negative advertising image may be alternately displayed on the EPD multiple times according to the refreshing sequence.

In the electronic label device of FIG. 3, the first color and the second color may be driven at a high voltage. The electronic label device may include other colors that are driven at a low voltage. The high voltage may be divided into a positive (+) high voltage and a negative (−) high voltage, and the low voltage may be divided into a positive (+) low voltage and a negative (−) low voltage.

According to one embodiment, the first color may be driven at a positive high voltage, and the second color may be driven at a negative high voltage. For example, the first color (white) may be driven at a positive high voltage (+12 V), and the second color (black) may be driven at a negative high voltage (−12 V). In this way, since the refreshing is performed for the colors that are driven at a high voltage, the refreshing effect can be maximized.

According to an additional aspect of the proposed invention, in the electronic label device, a plurality of advertising images may be alternately displayed on the EPD multiple times according to the refreshing sequence while the colors that are driven at a high voltage and the colors that are driven at a low voltage are distinguished from each other. When the first color is driven at a positive high voltage (e.g., +10 V), the second color is driven at a negative high voltage (e.g., −10 V), and the third color is driven at a lower (normal) voltage (e.g., +5 V, −5 V), multi-voltage driving may be performed for multiple colors such that the colors that are driven at a high voltage are alternately driven multiple times to complete refreshing and the colors that are driven at a normal voltage or low voltage are sequentially displayed only once to complete one refreshing cycle.

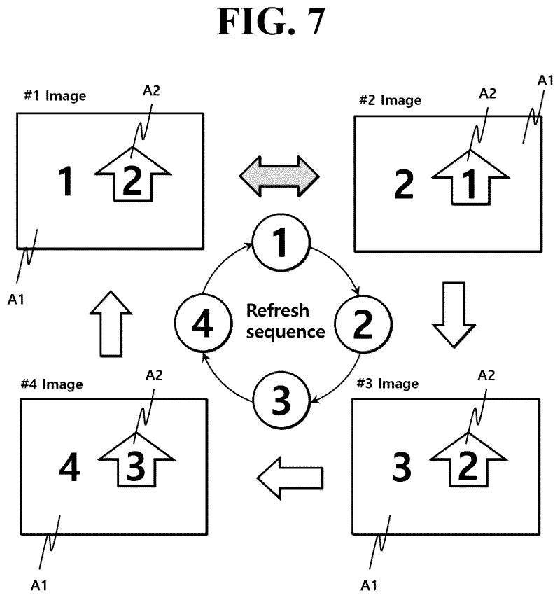

FIG. 7 shows a sequence chart in which four advertising images having different colors are sequentially displayed (\textcircled{1}\textcircled{2}\textcircled{3}\textcircled{4}) on the EPD according to a refreshing sequence while the colors that are driven at a high voltage and the colors that are driven at a low voltage are distinguished from each other, according to further another embodiment. The high voltage may be divided into a positive (+) high voltage and a negative (−) high voltage, and the low voltage may be divided into a positive (+) low voltage and a negative (−) low voltage.

As illustrated, the images stored in the non-volatile memory may include a first advertising image (#1 Image) formed of a first region A1 having a first color and a second region A2 having a second color, a second advertising image (#2 Image) formed of a first region A1 having the second color and a second region A2 having the first color, a third advertising image (#3 Image) formed of a first region A1 having a third color and a second region A2 having the second color, and a fourth advertising image (#4 Image) formed of a first region A1 having a fourth color and a second region A2 having the third color.

The first color may be driven at a higher positive high voltage (e.g., +12 V) than the third color, the second color may be driven at a lower negative high voltage (e.g., −12 V) than the fourth color, the third color may be driven at a lower positive low voltage (e.g., +6 V) than the first color, and the fourth color may be driven at a higher negative low voltage (e.g., −6 V) than the second color.

According to one embodiment, the refreshing control operation performed by the program may be an operation of driving the display driving circuit such that a process in which the first advertising image (#1 Image) and the second advertising image (#2 Image) are alternately displayed (\textcircled{1}) on the EPD multiple times, the third advertising image (#3 Image) is displayed on the EPD, and the fourth advertising image (#4 Image) is displayed (\textcircled{4}) on the EPD is repeated multiple times.

The first advertising image (#1 Image) and the second advertising image (#2 Image) may be a positive advertising image and a negative advertising image, respectively. In this way, since the refreshing is performed such that the advertising images having the colors that are driven at a high voltage are alternately displayed (\textcircled{1}) multiple times, the refreshing effect can be maximized.

According to an additional aspect of the proposed invention, the non-volatile memory may further store an updated product information image, and the program may perform a refreshing control operation according to a second event of the timer circuit for updating a product information display and then further perform a product information display update operation of driving the display driving circuit such that the EPD displays the updated product information image.

The product information image may be, for example, a product name, a price, a country of origin, etc. The product information image and the advertising image may be input to the communication circuit 110 in a compressed state using the DEFLATE algorithm according to the RFC 1951 standard.

According to an additional aspect of the proposed invention, the program may further perform a product information update operation of activating the communication circuit according to a third event of the timer circuit which is generated according to a wake-up cycle, checking whether there is data to be received by the electronic label device through the wireless communication circuit, and when there is data to be received, moving to a specific channel to receive updated product information, and storing the updated product information in the non-volatile memory. The product information may include metadata.

The electronic label device 100 may check whether there is data to be received according to the third event of the timer circuit 120 through a “broadcast channel.” The broadcast channel may be a channel through which information may be provided to a plurality of electronic label devices 100 simultaneously. When there is data to be received by the electronic label device 100, the electronic label device 100 may tune the channel to a data channel to receive updated product information and display the updated product information at a set time.

According to an additional aspect of the proposed invention, the electronic label device 100 may further include a display memory 180 that is connected to the display driving circuit and stores a plurality of images (see FIG. 2). The display memory 180 may be a non-volatile memory or a volatile memory and may store at least one of an advertising image, a product information image, and product information.

According to an additional aspect of the proposed invention, the electronic label device 100 may further include a direct memory access controller (DMAC) 190 that controls data transmission between the non-volatile memory 150 and the display memory 180.

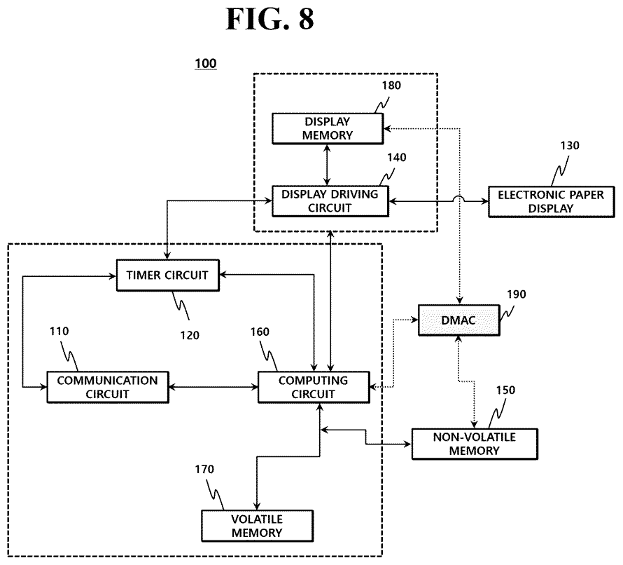

FIG. 8 is a block diagram showing a configuration of the electronic label device 100 with the DMAC 190 added to the block diagram of FIG. 2 according to one embodiment. The electronic label device 100 may further include the display memory 180 and the DMAC 190. The display memory 180 may be electrically connected to the DMAC 190. The DMAC 190 may be a controller that supports the movement of data between memories or between a memory and input and output devices “without intervention of the computing circuit 160.”

The DMAC 190 may copy the product information image and the advertising image stored in the non-volatile memory 150 and directly transmit the images to the display memory 180. “Directly” means that transmission and storage are performed “without intervention of the computing circuit 160,” and due to this, the speed of reading and writing operations of images (data) can be improved. The DMAC 190 may access and read data from a specific address of the non-volatile memory 150 and access and write data to a specific address of the display memory 180.

The display memory 180 may store the product information image and the advertising image. As described above, the advertising image may include a plurality of advertising images, such as a positive advertising image, a negative advertising image, a first advertising image, a second advertising image, and a third advertising image.

According to one embodiment, the display driving circuit 140 and the display memory 180 may be integrated into a single driver integrated circuit (IC) (see a dotted line).

According to the proposed invention, it is possible to avoid consumer misunderstanding of failure of an electronic label device during a refreshing process.

Furthermore, the proposed invention can provide advertising information for promoting product sales during a refreshing period.

Although the present invention has been described above through embodiments with reference to the attached drawings, the present invention is not limited thereto, and the embodiments should be interpreted to include various modified examples that can be obviously derived from the embodiments by those skilled in the art. The scope of the patent claims is intended to include these modified examples.

1. An electronic label device comprising:
a communication circuit;
a timer circuit;
an electronic paper display;
a display driving circuit operatively coupled to the electronic paper display;
a non-volatile memory storing a plurality of images and executable instructions, wherein the plurality of images have at least two regions arranged in substantially identical patterns and layouts but distinguished by different colors, each individual region has different colors assigned between images, and when any one region is focused on among the plurality of images, colors of corresponding regions are assigned according to a predetermined refreshing sequence; and
a computing circuit configured to execute the executable instructions to control the electronic label device,
wherein the images stored in the non-volatile memory include a positive advertising image formed of a first region having a first color and a second region having a second color. and a negative advertising image formed of a first region having the second color and a second region having the first color.
wherein the first color is driven at a positive high voltage and the second color is driven at a negative high voltage, and
wherein the executable instructions, when executed by the computing circuit, perform a refreshing control operation comprising:
(i) activating the display driving circuit according to a first event of the timer circuit which is generated according to a refreshing cycle, (ii) driving the first color at the positive high voltage while driving the second color at the negative high voltage to display the positive advertising image on the electronic paper display, and (iii) driving the first color at the negative high voltage while driving the second color at the positive high voltage to display the negative advertising image on the electronic paper display.
wherein (ii) and (iii) are alternately repeated multiple times without displaying an entire black screen or an entire white screen therebetween.

2. The electronic label device of claim 1, wherein the images stored in the non-volatile memory include a positive advertising image formed of a first region having a first color and a second region having a second color, and a negative advertising image formed of a first region having the second color and a second region having the first color, and
the refreshing control operation performed by the executable instructions is an operation of driving the display driving circuit such that the positive advertising image and the negative advertising image are alternately displayed on the electronic paper display multiple times.

3. The electronic label device of claim 1, wherein the images stored in the non-volatile memory include a first advertising image formed of a first region having a first color and a second region having a second color, a second advertising image formed of a first region having the second color and a second region having a third color, and a third advertising image formed of a first region having the third color and a second region having the first color, and
the refreshing control operation performed by the executable instructions is an operation of driving the display driving circuit such that a process in which the first advertising image, the second advertising image, and the third advertising image are sequentially displayed on the electronic paper display is repeated multiple times.

4. The electronic label device of claim 1, wherein the images stored in the non-volatile memory include a first advertising image formed of a first region having a first color and a second region having a second color, a second advertising image formed of a first region having the second color and a second region having a third color, a third advertising image formed of a first region having the third color and a second region having a fourth color, and a fourth advertising image formed of a first region having the fourth color and a second region having the first color, and
the refreshing control operation performed by the executable instructions is an operation of driving the display driving circuit such that a process in which the first advertising image, the second advertising image, the third advertising image, and the fourth advertising image are sequentially displayed on the electronic paper display is repeated multiple times.

5. The electronic label device of claim 2, wherein the first color is driven at a positive high voltage, and the second color is driven at a negative high voltage.

6. The electronic label device of claim 1, wherein the images stored in the non-volatile memory include a first advertising image formed of a first region having a first color and a second region having a second color, a second advertising image formed of a first region having the second color and a second region having the first color, a third advertising image formed of a first region having a third color and a second region having the second color, and a fourth advertising image formed of a first region having a fourth color and a second region having the third color,
the first color is driven at a higher positive high voltage than the third color,
the second color is driven at a lower negative high voltage than the fourth color,
the third color is driven at a lower positive low voltage than the first color,
the fourth color is driven at a higher negative low voltage than the second color, and
the refreshing control operation performed by the executable instructions is an operation of driving the display driving circuit such that a process in which the first advertising image and the second advertising image are alternately displayed on the electronic paper display multiple times, the third advertising image is displayed on the electronic paper display, and the fourth advertising image is displayed on the electronic paper display is repeated multiple times.

7. The electronic label device of claim 1, wherein the non-volatile memory further stores an updated product information image, and
the executable instructions perform a refreshing control operation according to a second event of the timer circuit for updating a product information display and then further performs a product information display update operation of driving the display driving circuit such that the electronic paper display displays the updated product information image.

8. The electronic label device of claim 7, wherein the executable instructions further perform a product information update operation of activating the communication circuit according to a third event of the timer circuit which is generated according to a wake-up cycle, checking whether there is data to be received by the electronic label device through the communication circuit, and when there is data to be received, moving to a specific channel to receive updated product information, and storing the updated product information in the non-volatile memory.

9. The electronic label device of claim 1, further comprising a display memory that is connected to the display driving circuit and stores the plurality of images.

10. The electronic label device of claim 9, further comprising a direct memory access controller (DMAC) that controls data transmission between the non-volatile memory and the display memory according to control of the computing circuit.
